(19) United States
(12) Patent Application Publication
(10) Pub. No.: US 2005/0050760 A1
(43) Pub. Date: Mar. 10, 2005

(54) Substrate drying method, substrate drying apparatus, and semiconductor device manufacturing method

(76) Inventor: Masamitsu Itoh, Yokohama-shi (JP)

Correspondence Address: Finnegan, Henderson, Farabow,;Garrett & Dunner, L.L.P., 1300 I Street, N.W., Washington, DC, 20005-3315, US

(21) Appl. No.: 10/868,031

(22) Filed: Jun. 16, 2004

(30) Foreign Application Priority Data
Jun. 18, 2003 (JP) 2003-173564

(51) Int. Cl. F26B 17/00

(52) U.S. Cl. 34/580

(57) ABSTRACT

A substrate drying method according to the present invention comprises disposing a flat plate which has an opening and which is equal to a substrate or larger than the substrate above the substrate to have a predetermined space between the flat plate and the substrate and discharging a gas from the opening, and moving, by the gas, a removal target on the substrate outside the substrate.

### CROSS-REFERENCE TO RELATED APPLICATIONS

This application is based upon and claims the benefit of priority from prior Japanese Patent Application No. 2003-173564, filed Jun. 18, 2003, the entire contents of which are incorporated herein by reference.

### BACKGROUND OF THE INVENTION

1. Field of the Invention

The present invention relates to a substrate drying method, a substrate drying apparatus, and a semiconductor device manufacturing method, and relates in particular to a substrate drying method, a substrate drying apparatus, and a semiconductor device manufacturing method which are applied to drying of a substrate after a wet process in, for example, a semiconductor manufacturing step, a photomask manufacturing step or a flat display manufacturing step.

2. Description of the Related Art

In recent years, problems in a photolithography step in a semiconductor manufacturing process have been obvious. As miniaturization of semiconductor devices progresses, more demands for miniaturization in the photolithography step have been made. A design rule of the devices has already reached a miniaturization of 0.1 μm, and about 6 nm is required in dimensional precision of patterns that must be controlled, which is significantly strict. Further, more stringent requirements are being made concerning defects such as stains on the substrates after cleaned.

Under these circumstances, there is a problem of defects caused in the substrate when the substrate is dried at the end of a conventional wet process such as a cleaning process. Spin drying has heretofore been performed in which a substrate to be treated is rotated to fling a liquid on the surface of the substrate by centrifugal force. In accordance with the spin drying, the flung liquid collides with a sidewall of a drying chamber, and is scattered and floats as mist, thus again sticking to the substrate. As the mist which has again stuck thereto evaporates, components contained in the mist will separate and become defects on the substrate.

Furthermore, rotation of the substrate causes the liquid on the substrate to move swiftly when the liquid is moved by the centrifugal force, so that part of the liquid becomes small liquid drops to remain on the substrate. The liquid drops are not moved outside the substrate by the centrifugal force, and evaporate on the substrate. Also in this case, components contained in the liquid drops will separate and become defects on the substrate.

### BRIEF SUMMARY OF THE INVENTION

According to an aspect of the invention, there is provided a substrate drying method comprising: disposing a flat plate which has an opening and which is equal to a substrate or larger than the substrate above the substrate to have a predetermined space between the flat plate and the substrate; and discharging a gas from the opening, and moving, by the gas, a removal target on the substrate outside the substrate.

According to another aspect of the invention, there is provided a substrate drying apparatus comprising: a flat plate which is disposed above a substrate and which has an opening and which is equal to the substrate or larger than the substrate; a discharge mechanism which discharges a gas from the opening; and control means for disposing the flat plate to have a predetermined space between the flat plate and the substrate, and controlling by the discharge mechanism to discharge the gas from the opening.

According to another aspect of the invention, there is provided a semiconductor device manufacturing method comprising: disposing a flat plate which has an opening and which is equal to a substrate for a semiconductor or larger than the substrate above the substrate to have a predetermined space between the flat plate and the substrate; and discharging a gas from the opening, and moving, by the gas, a removal target on the substrate outside the substrate.

### BRIEF DESCRIPTION OF THE SEVERAL VIEWS OF THE DRAWING

FIG. 1 is a side view showing a schematic configuration of a scan cleaning apparatus to which a substrate drying apparatus according to an embodiment of the present invention is applied;

FIG. 2A and FIG. 2B are diagrams showing a schematic configuration of a substrate holder according to the embodiment of the present invention;

FIG. 3 is a bottom view showing a schematic configuration of a scan nozzle according to the embodiment of the present invention;

FIG. 4 is a front sectional view showing the schematic configuration of the scan nozzle according to the embodiment of the present invention;

FIG. 5A, FIG. 5B and FIG. 5C are diagrams showing an operation of the scan nozzle in a substrate cleaning step according to the embodiment of the present invention;

FIG. 6A and FIG. 6B are diagrams showing the schematic configuration of the substrate drying apparatus according to the embodiment of the present invention; and

FIG. 7A, FIG. 7B, FIG. 7C and FIG. 7D are sectional views showing an operation of the substrate drying apparatus in a substrate drying step according to the embodiment of the present invention.

### DETAILED DESCRIPTION OF THE INVENTION

An embodiment of the present invention will be described below in reference to the drawings.

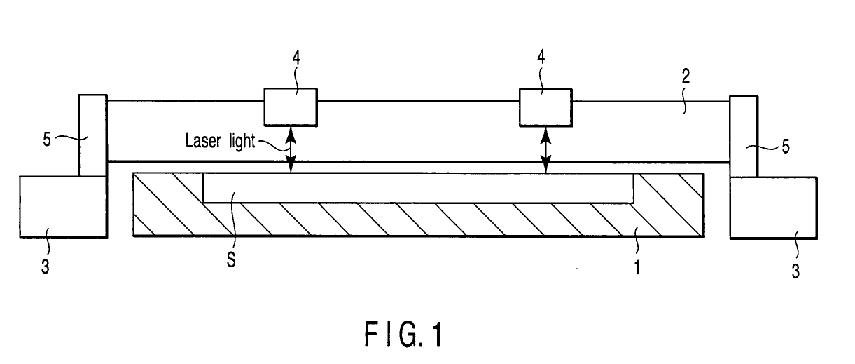

FIG. 1 is a side view showing a schematic configuration of a scan cleaning apparatus (6-inch square substrate cleaning apparatus) to which a substrate drying apparatus according to the embodiment of the present invention is applied.

A chemical supply section (hereinafter referred to as a scan nozzle) 2 is disposed above a round substrate holder 1. The substrate holder 1 is placed between scan stages 3, 3. A substrate to be treated (mask substrate) S is held almost horizontally to the substrate holder 1. The scan nozzle 2 extends between the scan stages 3, 3 via an unshown holding member. The scan nozzle 2 can move in a forward and backward direction in the drawing along the scan stages 3, 3.

As described later, a predetermined space is provided between the substrate holder 1 and the scan nozzle 2. Further, the substrate holder 1 has a double disk structure as described later. Two gap measuring systems 4, 4 using a laser light are attached to one side surface of the scan nozzle 2. The gap measuring systems 4, 4 measure the distance (gap value) between the substrate S and the scan nozzle 2.

Gap adjustment mechanisms 5, 5 are placed between both ends (holding members) of the scan nozzle 2 and the scan stages 3, 3, respectively. The gap adjustment mechanisms 5, 5 move the scan nozzle 2 in a vertical direction with a piezo element. The gap adjustment mechanisms 5, 5 adjust the height of the scan nozzle 2 so that the gap values measured by the gap measuring systems 4, 4 are maintained at desired values.

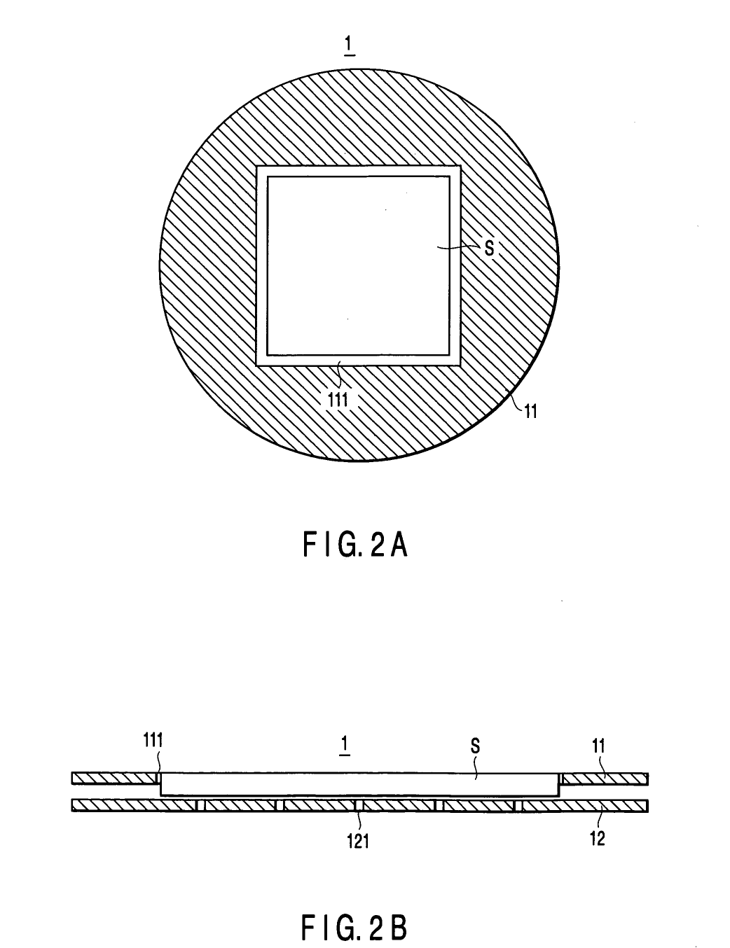

FIG. 2A is an upper view of the substrate holder 1, and FIG. 2B is a front sectional view thereof. The substrate holder 1 is a double disk in which two disks 11, 12 having a diameter of about 300 mm and a thickness of about 2 mm are stacked with a space of about 5 mm, and has a total thickness of about 9 mm. A square opening 111 which is 153 mm square is provided in the center of the upper disk 11. The lower disk 12 comprises a plurality of chucks 121 for vacuum chuck of the substrate S. It is to be noted that the upper disk 11 is coupled to the lower disk 12 by a plurality of unshown props.

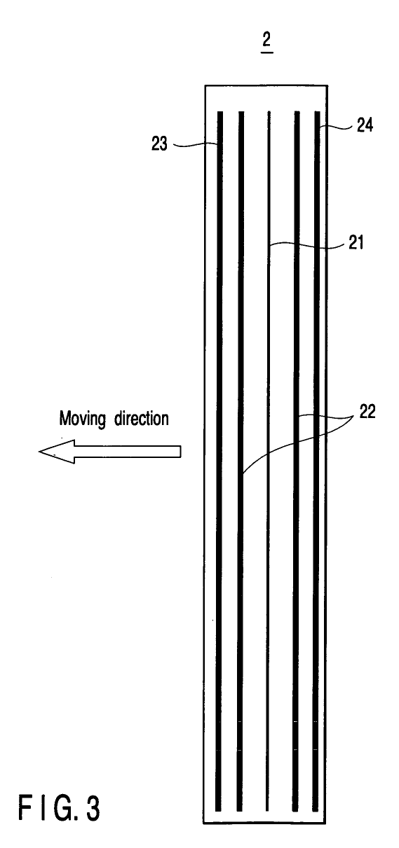

FIG. 3 is a bottom view of the scan nozzle 2. The scan nozzle 2 has a width of about 5 cm in its moving direction, and has a length of about 18 cm in a direction vertical to the moving direction. Further, a lower surface of the scan nozzle 2 facing the substrate S is provided with slit openings.

A central opening is a chemical supply slit 21, and discharges a chemical (cleaning liquid). Openings on both sides of the chemical supply slit 21 are suction slits 22, 22, and the suction slits 22, 22 suck the chemical on the substrate. Openings outside the suction slits 22, 22 are a pre-wet liquid supply slit 23 and a rinse liquid supply slit 24. The pre-wet liquid supply slit 23 discharges a pre-wet liquid. The rinse liquid supply slit 24 discharges a rinse liquid. In other words, the pre-wet liquid supply slit 23 is provided on a front side and the rinse liquid supply slit 24 is provided on a rear side in the moving direction of the scan nozzle 2.

The chemical supply slit 21 has a length of about 150 mm and a width of about 1 mm. The suction slits 22, 22 have a length of about 155 mm and a width of about 1 mm. The pre-wet liquid supply slit 23 and the rinse liquid supply slit 24 have a length of about 155 mm and a width of about 2 mm. By balancing discharge force of the chemical supply slit 21 with suction force of the suction slits 22, 22 on both sides, the chemical coming out of the chemical supply slit 21 does not run outside the suction slits 22, 22. The pre-wet liquid and the rinse liquid are supplied by pumps from the pre-wet liquid supply slit 23 and the rinse liquid supply slit 24, respectively.

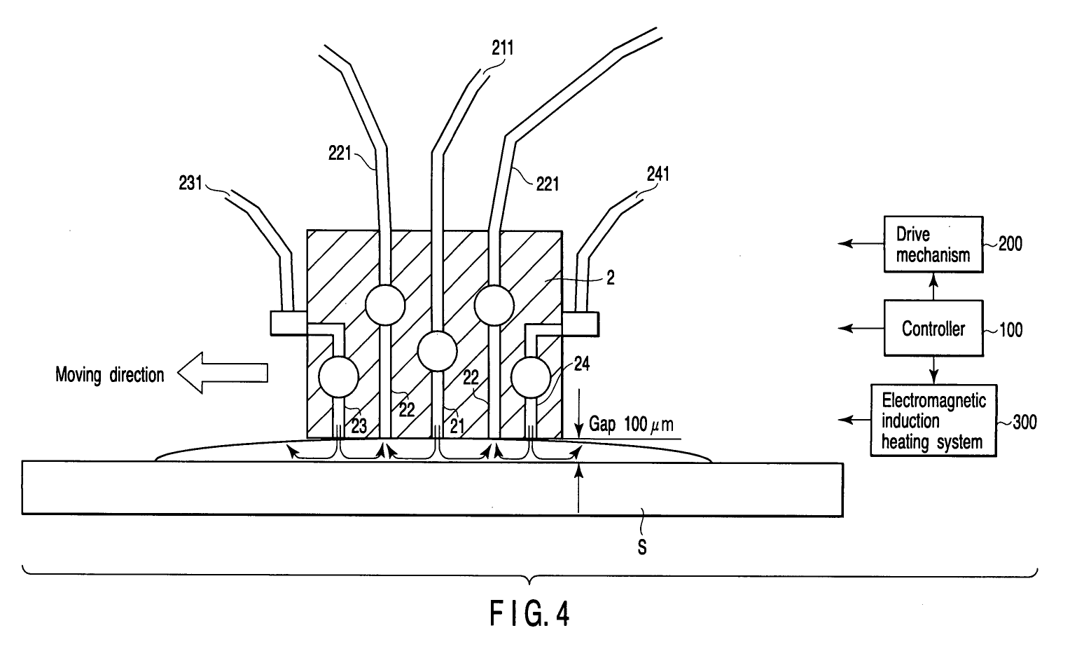

FIG. 4 is a front sectional view of the scan nozzle 2. In FIG. 4, spaces between the chemical supply slit 21 and the suction slits 22, 22 are about 5 mm, a space between the suction slit 22 and the pre-wet liquid supply slit 23 and a space between the suction slit 22 and the rinse liquid supply slit 24 are about 5 mm. A space between the surface of the substrate S and the lower surface of the scan nozzle 2 can be varied in a range of 0 to 500 μm by the gap adjustment mechanisms 5, 5 described above, and can be controlled while the scan nozzle 2 is scanning (moving) by a controller 100.

Furthermore, a chemical line 211 is coupled to the chemical supply slit 21, suction lines 221, 221 are coupled to the suction slits 22, 22, a pre-wet liquid line 231 is coupled to the pre-wet liquid supply slit 23, and a rinse liquid line 241 is coupled to the rinse liquid supply slit 24.

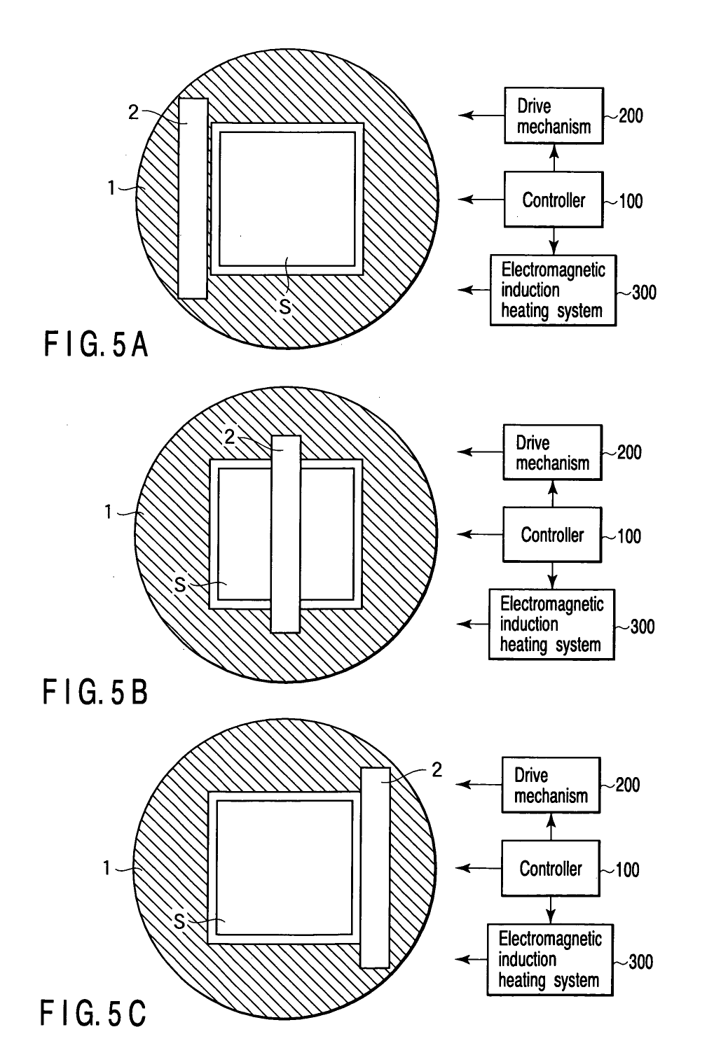

FIG. 5A, FIG. 5B and FIG. 5C are diagrams showing an operation of the scan nozzle 2 in a substrate cleaning step. The following operation is performed under the control of the controller 100. The substrate S is placed in the opening 111 of the upper disk 11 in the substrate holder 1, and vacuum-chucked on the lower disk 12. At this point, an upper surface of the substrate holder 1 (upper surface of the upper disk 11) and an upper surface of the substrate S are substantially in the same plane. In this state, the scan nozzle 2 can scan from an end of the substrate holder 1 to the substrate S, and further to the other end of the substrate holder 1, as shown in FIG. 5A, FIG. 5B and FIG. 5C. The scan nozzle 2 is evacuated from the substrate holder 1 after the substrate cleaning step is completed.

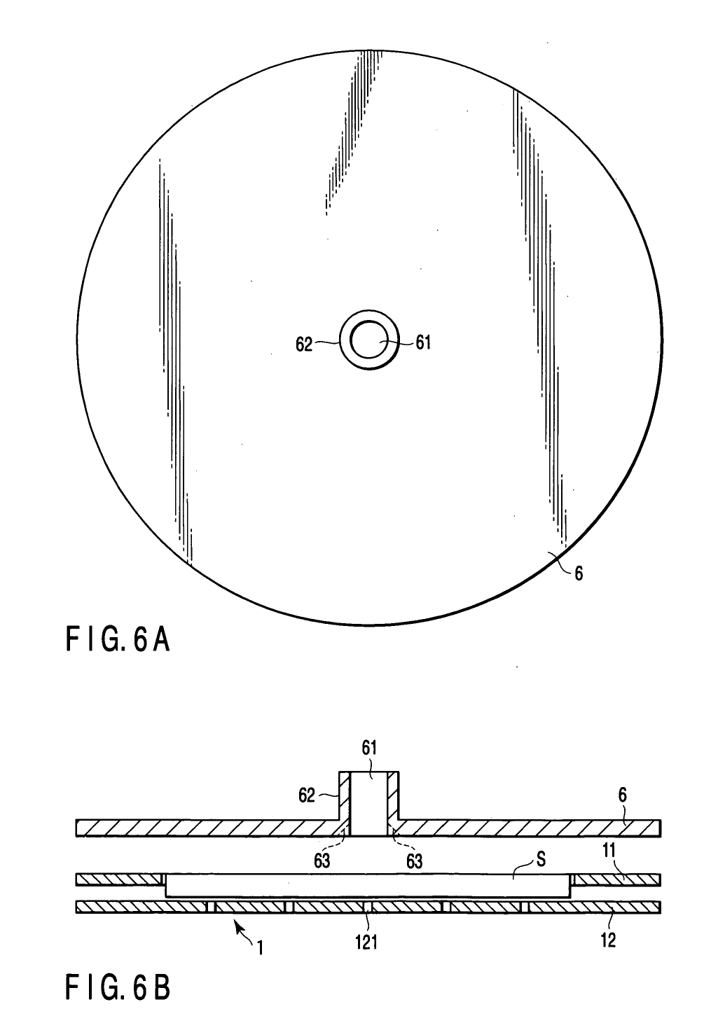

FIG. 6A is an upper view showing the schematic configuration of the substrate drying apparatus according to the embodiment of the present invention, and FIG. 6B is a front sectional view thereof. This substrate drying apparatus is constituted of the substrate holder 1 described above and a dry disk 6.

The dry disk 6 is made of an aluminum flat plate having a diameter of about 300 mm and a thickness of about 5 mm, and is located almost horizontally above the substrate S to completely cover the substrate S. The metallic drying flat plate can prevent static electricity. Naturally, other flat plates having an electrification preventing function can also be used. An opening 61 having a diameter of about 3 mm is provided in the center of the dry disk 6. A pipe 62 to lead a nitrogen gas onto the substrate S is provided on a periphery of the opening 61 in the upper surface of the dry disk 6. It is to be noted that a notch 63 indicated by broken lines can be provided on the periphery of the opening 61 on a lower surface of the dry disk 6 to lead the nitrogen gas onto the substrate S in a wide range.

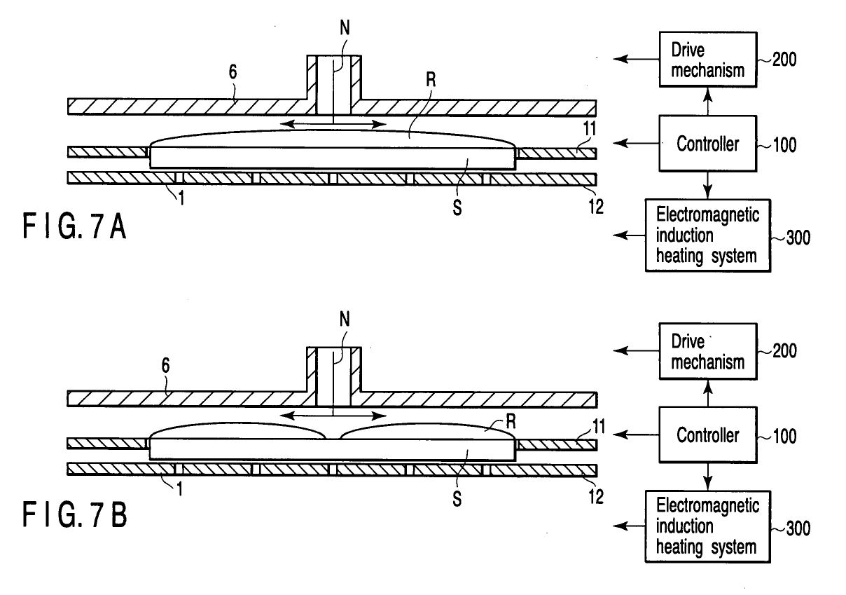

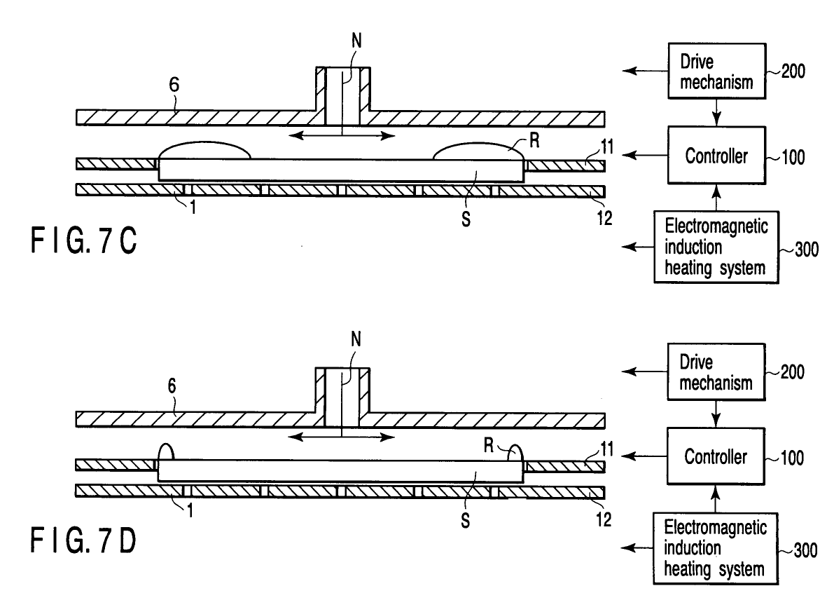

FIG. 7A, FIG. 7B, FIG. 7C and FIG. 7D are sectional views showing an operation of the substrate drying apparatus in a substrate drying step. The following operation is performed under the control of the controller 100. A rinse liquid R is mounted on the substrate S which has been cleaned by the scan nozzle 2 in the substrate cleaning step. In this drying sequence, the dry disk 6 is put down from above by a drive mechanism 200, and stopped at a position 3 mm away from the surface of the substrate S as shown in FIG. 7A, and then a nitrogen gas N is discharged from the opening 61. This nitrogen gas N is supplied from an unshown nitrogen gas supply device, and discharged from the opening 61 to the surface of the substrate S via the pipe 62.

Thereby, as shown in FIG. 7B, FIG. 7C and FIG. 7D, the rinse liquid R on the substrate S is carried away from the center of the substrate to the end of the substrate by the nitrogen gas N, so that the substrate S is dried from the center to the end. The rinse liquid R reaching the end of the substrate flows downward through a clearance between the substrate S and the upper disk 11 of the substrate holder 1, and reaches a space between the upper disk 11 and the lower disk 12.

After the rinse liquid R on the surface of the substrate S has been almost eliminated, the substrate S is rotated together with the substrate holder 1 by the drive mechanism 200 while the nitrogen gas N is being discharged, thereby draining the rinse liquid R sticking to an end face and rear surface of the substrate.

Functions of the present embodiment will be described below.

First, a photomask substrate in which a Cr film is formed on a quartz substrate that is 6-inch square is taken as the substrate S, and the photomask substrate is inspected by a foreign object inspection device M1320 (manufactured by Lasertec Corporation) before cleaned. As a result, a great number of foreign objects are detected as shown in Table 1.

TABLE 1

| | |
|---|---|
| | Conventional |
| Present embodiment | method |

| | Before | After | Before | After |
|---|---|---|---|---|
| Size of | cleaning | cleaning | cleaning | cleaning |
| foreign | and | and | and | and |
| object | drying | drying | drying | drying |
| 1 μm or | 5 | 0 | 4 | 1 |
| more | | | | |
| 0.5 to | 28 | 0 | 31 | 48 |
| 1 μm | | | | |
| 0.5 μm | 57 | 1 | 51 | 40 |
| or less | | | | |

Next, the photomask substrate is set to the scan cleaning apparatus described above. Ozone water having a concentration of 5 ppm is used as the chemical. Then, under the control of the controller 100, the scan nozzle 2 scans the photomask substrate at a velocity of 3 mm/sec, and the photomask substrate is cleaned with the ozone water and rinsed with the rinse liquid. At this moment, the rinse liquid is mounted with a thickness of about 1.5 mm on the photomask substrate.

Next, under the control of the controller 100, the dry disk 6 located above the photomask substrate is put down and stopped at a position 3 mm high from the surface of the mask substrate by the drive mechanism 200. Subsequently, under the control of the controller 100, the nitrogen gas supply device starts gradually discharging, from the opening 61 via the pipe 62, the nitrogen gas which is adjusted to normal temperature or higher (23° C. or higher, a temperature above ambient temperature), for example, 50° C. by an electromagnetic induction heating system 300.

Subsequently, the nitrogen gas is discharged for three minutes while a flow amount is being increased so that a relationship between time and the flow amount may be 1 L/(minute)², and then the nitrogen gas is continuously discharged maintaining a flow amount of 3 L/minute. It is to be noted that the discharge may be stopped or the flow amount may be reduced after the nitrogen gas is discharged for three minutes while the flow amount is increased.

Thus, the rinse liquid on the photomask substrate moves from the center of the substrate to the outside, and flows from a clearance between the substrate holder 1 and the photomask substrate to a clearance of the double disk of the substrate holder 1, thereby gradually drying the photomask substrate. In this way, most of the rinse liquid on the photomask substrate can be removed while mist and particles in the atmosphere do not stick again to the photomask substrate.

Next, while the nitrogen gas is being discharged, the photomask substrate is rotated for ten minutes at a rotation velocity of 300 rpm by the drive mechanism 200 under the control of the controller 100, thereby draining the rinse liquid sticking to the end face and rear surface of the substrate. Also in this case, the fresh nitrogen gas always flows between the dry disk 6 and the photomask substrate, so that the photomask substrate can be dried while particles and mist do not stick again to the mask substrate.

The surface of the photomask substrate is again subjected to the foreign object inspection by the foreign object inspection device M1320, and it can be ascertained that foreign objects are almost completely removed as shown in Table 1. For comparison, results when the drying step is performed by conventional spin drying are also shown in Table 1. As apparent from these results, only a difference of drying step leads to a great difference in the number of foreign objects remaining on the substrate after cleaned, even though the same cleaning step is performed.

In the conventionally implemented spin drying, the substrate is rotated to fling the liquid on the surface of the substrate by centrifugal force, but the flung liquid collides with a sidewall of a drying chamber, and is scattered and floats as mist, thus again sticking to the substrate. As the mist which has again stuck thereto evaporates, components contained in the mist will separate and become defects on the substrate. Moreover, the rotation of the substrate causes the liquid on the substrate to move swiftly when the liquid is moved by the centrifugal force, so that part of the liquid becomes small liquid drops to remain on the substrate. The liquid drops are not moved outside the substrate by the centrifugal force, and evaporate on the substrate. Also in this case, components contained in the liquid drops will separate and become defects on the substrate. Thus, in the conventional spin drying, mist and particles flying in the air stick again onto the dried substrate to cause defects on the surface of the substrate.

On the contrary, in the present embodiment, the flat plate equal to or larger than the substrate is disposed above the substrate on which the liquid is mounted, at a height at which the flat plate does not touch the liquid on the substrate, and an inert gas such as the nitrogen gas is discharged from the opening provided in the center of the flat plate to gradually move the liquid on the substrate from the center of the substrate to the outside. Thereby, the liquid drops can be moved to the outside of the substrate without remaining on the substrate. Subsequently, the substrate is rotated while the gas is being discharged from the flat plate. This makes it possible to prevent mist from sticking again to the substrate which has been a problem in the conventional spin drying, and to also prevent water stains, water glass or the like from being caused, allowing a significantly clean dried surface to be obtained.

It is to be noted that an example of the substrate holder having a shape of the double disk has been shown in the present embodiment, but substrate holders having other shapes can also be applied. Moreover, the opening for gas discharge provided in the dry disk is not exclusively provided in the center of the dry disk, but can be provided at an optional position at which the entire surface of the substrate can be dried by the gas. Further, the number of openings is not limited to one, and an optional number is possible. Still further, the space between the dry disk and the substrate is not limited to 3 mm, but can be varied depending on the thickness of the liquid on the substrate and the flow amount of the discharged gas. The space can also be effectively varied by gradually being reduced during a drying treatment.

Furthermore, application of a mask manufacturing process to the cleaning step has been shown in the present embodiment, but it is not limited thereto and can be applied to a flat panel display manufacturing step, or any wet process such as resist peeling, removal of a surface natural oxide film or cleaning in a wafer process of a semiconductor device manufacturing step. Thus, the present embodiment described above can be applied to a substrate for a semiconductor (semiconductor substrate).

According to the embodiment of the present invention, a drying method can be provided to prevent defects from being caused by preventing mist from sticking again onto the substrate and preventing the liquid drops from remaining on the substrate when the substrate is dried.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A substrate drying method comprising:
disposing a flat plate which has an opening and which is equal to a substrate or larger than the substrate above the substrate to have a predetermined space between the flat plate and the substrate; and
discharging a gas from the opening, and moving, by the gas, a removal target on the substrate outside the substrate.

2. The substrate drying method according to claim 1, comprising rotating the substrate.

3. The substrate drying method according to claim 1, wherein the opening is provided in the center of the substrate.

4. The substrate drying method according to claim 1, wherein the gas is at normal temperature or higher.

5. The substrate drying method according to claim 1, wherein the gas is an inert gas.

6. The substrate drying method according to claim 1, wherein the gas is a nitrogen gas.

7. The substrate drying method according to claim 1, comprising increasing a flow amount of the gas along with passage of time from the start of gas discharge, and maintaining a constant flow amount after discharging the gas for a predetermined time.

8. A substrate drying apparatus comprising:
a flat plate which is disposed above a substrate and which has an opening and which is equal to the substrate or larger than the substrate;
a discharge mechanism which discharges a gas from the opening; and
control means for disposing the flat plate to have a predetermined space between the flat plate and the substrate, and controlling by the discharge mechanism to discharge the gas from the opening.

9. The substrate drying apparatus according to claim 8, comprising means for rotating the substrate.

10. The substrate drying apparatus according to claim 8, wherein the opening is provided in the center of the substrate.

11. The substrate drying apparatus according to claim 8, comprising means for adjusting the gas to normal temperature or higher.

12. The substrate drying apparatus according to claim 8, wherein the control means increases a flow amount of the gas along with passage of time from the start of gas discharge, and maintains a constant flow amount after discharging the gas for a predetermined time.

13. A semiconductor device manufacturing method comprising:
disposing a flat plate which has an opening and which is equal to a substrate for a semiconductor or larger than the substrate above the substrate to have a predetermined space between the flat plate and the substrate; and
discharging a gas from the opening, and moving, by the gas, a removal target on the substrate outside the substrate.
